(19) United States
(12) Patent Application Publication
(10) Pub. No.: US 2026/0017888 A1
(43) Pub. Date: Jan. 15, 2026

(54) RECONSTRUCTION METHOD AND APPARATUS FOR THREE-DIMENSIONAL ENTITY MODEL, DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Ziang CHENG, Shenzhen (CN); Shenzhou CHEN, Shenzhen (CN); Pan JI, Shenzhen (CN); Hongdong LI, Shenzhen (CN)

(21) Appl. No.: 19/333,505

(22) Filed: Sep. 19, 2025

Related U.S. Application Data
(63) Continuation of application No. PCT/CN2024/114539, filed on Aug. 26, 2024.

(30) Foreign Application Priority Data
Oct. 30, 2023 (CN) 202311416241.X

(51) Int. Cl. G06T 17/20; G06T 17/00

(52) U.S. Cl. CPC G06T 17/20; G06T 17/005

(57) ABSTRACT

A three-dimensional (3D) entity model reconstruction method performed by a computer device includes obtaining 3D spatial information corresponding to a 3D entity model, performing voxel partitioning on the 3D entity model based on the 3D spatial information to determine voxels corresponding to the 3D entity model and connected in a tree structure, and constructing a 3D mesh corresponding to the 3D entity model based on the voxels. The voxels are distributed on a surface of the 3D entity model and represent a geometric shape of the surface of the 3D entity model.

### CROSS-REFERENCE TO RELATED APPLICATIONS

This application is a continuation of International Application No. PCT/CN2024/114539, filed on Aug. 26, 2024, which claims priority to Chinese Patent Application No. 202311416241.X, entitled “RECONSTRUCTION METHOD AND APPARATUS FOR THREE-DIMENSIONAL ENTITY MODEL, DEVICE, MEDIUM, AND PROGRAM PRODUCT,” and filed on Oct. 30, 2023, the entire contents of which are incorporated herein by reference.

### FIELD OF THE TECHNOLOGY

This application relates to the field of computer vision, and in particular, to a reconstruction method and apparatus for a three-dimensional entity model, a device, a medium, and a program product.

### BACKGROUND OF THE DISCLOSURE

A three-dimensional (3D) model reconstruction technology may convert a 3D entity model into a 3D digital model, and the 3D digital model may be conveniently stored, edited, analyzed, and transmitted. The 3D model reconstruction technology is widely applied to fields of game rendering, augmented reality (AR), virtual reality (VR), and artificial intelligence generated content (AIGC).

In the related art, a deep marching tetrahedra (DMTet) method is used to represent a surface of the 3D entity model with a deformable tetrahedral mesh, converting signed distance field (SDF) values into a 3D mesh representation corresponding to the 3D entity model.

However, in the related art, when performing multiple subdivisions of the tetrahedral mesh near the surface of the 3D entity model, sharp and slender tetrahedral meshes are generated, resulting in inaccuracies in the 3D mesh, and consequently leading to inaccurate reconstruction of the 3D entity model.

### SUMMARY

In accordance with the disclosure, there is provided a three-dimensional (3D) entity model reconstruction method performed by a computer device and including obtaining 3D spatial information corresponding to a 3D entity model, performing voxel partitioning on the 3D entity model based on the 3D spatial information to determine voxels corresponding to the 3D entity model and connected in a tree structure, and constructing a 3D mesh corresponding to the 3D entity model based on the voxels. The voxels are distributed on a surface of the 3D entity model and represent a geometric shape of the surface of the 3D entity model.

Also in accordance with the disclosure, there is provided a computer device including a processor, and a memory storing a computer program that, when executed by the processor, causes the computer device to obtain 3D spatial information corresponding to a 3D entity model, perform voxel partitioning on the 3D entity model based on the 3D spatial information to determine voxels corresponding to the 3D entity model and connected in a tree structure, and construct a 3D mesh corresponding to the 3D entity model based on the voxels. The voxels are distributed on a surface of the 3D entity model and represent a geometric shape of the surface of the 3D entity model.

Also in accordance with the disclosure, there is provided a non-transitory computer-readable storage medium storing a computer program that, when executed by a processor, causes a computer device including the processor to obtain 3D spatial information corresponding to a 3D entity model, perform voxel partitioning on the 3D entity model based on the 3D spatial information to determine voxels corresponding to the 3D entity model and connected in a tree structure, and construct a 3D mesh corresponding to the 3D entity model based on the voxels. The voxels are distributed on a surface of the 3D entity model and represent a geometric shape of the surface of the 3D entity model.

### BRIEF DESCRIPTION OF THE DRAWINGS

FIG. 1 illustrates a structural block diagram of a computer system according to an exemplary embodiment.

FIG. 2 illustrates a schematic diagram showing a reconstruction method for a three-dimensional (3D) model according to an exemplary embodiment.

FIG. 3 illustrates a flowchart of a reconstruction method for a 3D model according to an exemplary embodiment.

FIG. 4 illustrates a flowchart of a reconstruction method for a 3D model according to an exemplary embodiment.

FIG. 5 illustrates a flowchart of a reconstruction method for a 3D model according to an exemplary embodiment.

FIG. 6 illustrates a flowchart of a reconstruction method for a 3D model according to an exemplary embodiment.

FIG. 7 illustrates a flowchart of a reconstruction method for a 3D model according to an exemplary embodiment.

FIG. 8 illustrates an overall framework diagram showing a reconstruction method for a 3D model according to an exemplary embodiment.

FIG. 9 illustrates a schematic diagram showing a voxel distribution of a 3D entity model according to an exemplary embodiment.

FIG. 10 illustrates a schematic diagram showing position codes based on an octree according to an exemplary embodiment.

FIG. 11 illustrates a schematic diagram showing a reconstruction method for a 3D entity model according to an exemplary embodiment.

FIG. 12 illustrates a schematic diagram showing a reconstruction method for a 3D entity model according to an exemplary embodiment.

FIG. 13 illustrates a block diagram of a reconstruction apparatus for a 3D entity model according to an exemplary embodiment.

FIG. 14 illustrates a structural block diagram of a computer device according to an exemplary embodiment.

### DESCRIPTION OF EMBODIMENTS

Terms used in this application are merely intended to describe objectives of specific embodiments, but are not intended to limit this application. Singular forms of “a,” “an,” and “the” used in this application and the appended claims are intended to include plural forms as well, unless the context clearly indicates otherwise. The term “and/or” used herein indicates and includes any or all possible combinations of one or more associated listed items.

Although the terms such as “first,” “second” may be used in this application to describe various information, the information is not to be limited to these terms. These terms are merely used to distinguish between information of the same type. For example, without departing from the scope of this application, a first parameter may alternatively be referred to as a second parameter, and similarly, the second parameter may alternatively be referred to as the first parameter. Depending on the context, for example, the word “if” used herein may be interpreted as “while,” or “when,” or “in response to determination.”

In this application, before and during collection of relevant data of a user (for example, data of a three-dimensional (3D) entity model related to the user), a prompt interface or a pop-up window may be displayed, or speech prompt information may be outputted. The prompt interface, the pop-up window, or the speech prompt information is configured for prompting the user that the relevant data of the user is currently being collected. In this way, in this application, only after a confirmation operation performed by the user for the prompt interface or the pop-up window is obtained, relevant operations of obtaining the relevant data of the user start to be performed. Otherwise (i.e., when the confirmation operation performed by the user for the prompt interface or the pop-up window is not obtained), the relevant operations of obtaining the relevant data of the user are ended, that is, the relevant data of the user is not obtained. In other words, all user data collected in this application are collected with the user's consent and authorization, and the collection, use, and processing of user-related data need to comply with relevant laws, regulations, and standards in relevant countries and regions.

First, terms involved in embodiments of this application are briefly introduced.

Octree: An octree is a tree data structure configured for describing a 3D space. The octree can recursively partition space into eight equal cubic sub-regions until a given termination condition is met. Each node in the octree represents a cubic volume element, and each node has eight child nodes. A volume of a parent node equals a sum of the volume elements represented by the eight child nodes. The octree may efficiently query, insert, and delete objects in the space.

Signed distance field (SDF): An SDF is a data structure configured for representing and operating a geometric shape. The SDF is a scalar field configured for mapping each point in space to a real value, where the real value represents a signed distance from that point to a surface of the geometric shape. The real value is also referred to as a signed distance field (SDF) value, and the SDF value is a one-dimensional floating-point number. Specifically, an SDF value for a point on the surface of the shape is 0, an SDF value for a point inside the shape is negative, and an SDF value for a point outside the shape is positive.

Voxel: “Voxel” is a portmanteau of “volume” and “pixel.” The voxel may be regarded as a pixel in a 3D space and represents a minimum unit in a 3D space segmentation. The voxel is configured for representing a spatial unit and has a specific size and position, allowing it to store specific attributes. The voxel is widely used in computer vision fields such as 3D imaging, scientific data, and medical imaging.

Marching cubes (MC) algorithm: An MC algorithm is a computer graphics algorithm configured for generating a surface of a 3D model. It is primarily configured for extracting an isosurface from a 3D scalar field, and may generate a relatively accurate and smooth surface.

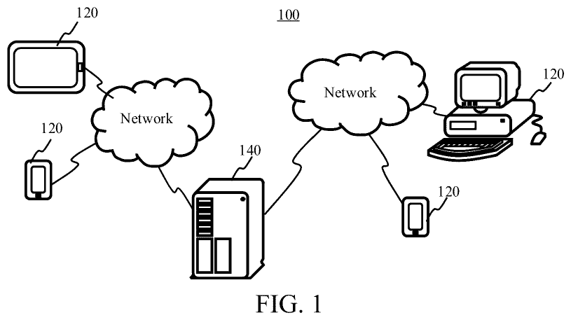

FIG. 1 illustrates a structural block diagram of a computer system 100 according to an exemplary embodiment of this application. The computer system 100 may be implemented as a system architecture of a reconstruction method for a 3D entity model. The computer system 100 includes a terminal 120 and a server 140.

The terminal 120 may be an electronic device such as a mobile phone, a tablet computer, an on board terminal (in-vehicle infotainment system), a wearable device, a personal computer (PC), and an unmanned reservation terminal. A client running a target application may be installed on the terminal 120. The target application may be an application for 3D data processing, display, reconstruction of a 3D entity model, and rendering of a 3D mesh, or it may be another application that provides functions for 3D data processing, display, reconstruction of a 3D entity model, and rendering of a 3D mesh. This is not limited in this application. In addition, a form of the target application is not limited in this application, and includes, but is not limited to an application (APP), a mini program, and the like that are installed on the terminal 120, or may be in a form of a web page.

The server 140 may be an independent physical server, a server cluster or distributed system including a plurality of physical servers, or a cloud server providing basic cloud computing services such as a cloud computing service, a cloud database, cloud computing, a cloud function, cloud storage, a network service, cloud communication, a middleware service, a domain name service, a security service, a content delivery network (CDN), and a big data and artificial intelligence platform. The server 140 may be a backend server of the target application, and is configured to provide a backend service for the client of the target application.

Cloud technology refers to a hosting technology that unifies a series of resources such as hardware, software, and networks in a wide area network or a local area network to implement computing, storage, processing, and sharing of data. The cloud technology is a collective name for a network technology, an information technology, an integration technology, a platform management technology, an application technology, and the like based on an application of a cloud computing business mode. It may form a resource pool for on-demand use, providing flexibility and convenience. A cloud computing technology becomes an important support. A backend service of a technical network system requires substantial computing and storage resources, such as a video website, a picture website, and more portal websites. With the rapid development and application of the Internet industry, it is likely that every item will have its own identification mark in the future. The identification mark needs to be transmitted to the backend system for logical processing. Data of different levels will be processed separately. All types of industry data require a powerful system support, and this can be implemented only through cloud computing.

In some embodiments, the server 140 may alternatively be implemented as a node in a blockchain system. Blockchain is a new application mode of computer technologies such as distributed data storage, point-to-point transmission, a consensus mechanism, and an encryption algorithm. The blockchain, essentially a decentralized database, is a string of data blocks generated using cryptographic methods. Each data block includes information about a batch of network transactions, which is configured for verifying validity of the information (anti-counterfeiting) and generating a next block. The blockchain may include an underlying blockchain platform, a platform product service layer, and an application service layer.

The terminal 120 and the server 140 may communicate with each other by using a network, for example, a wired or wireless network.

In the reconstruction method for a 3D entity model provided in this embodiment of this application, an execution body for each operation may be a computer device. The computer device is an electronic device having data computing, processing, and storage capabilities. Taking a solution implementation environment shown in FIG. 1 as an example, the terminal 120 may perform the reconstruction method for a 3D entity model (for example, the client of the target application installed and running on the terminal 120 performs the reconstruction method for a 3D entity model), or the server 140 may perform the reconstruction method for a 3D entity model, or the terminal 120 and the server 140 interact and cooperate to perform the reconstruction method for a 3D entity model. This is not limited in this application.

A person skilled in the art may know that the number of the terminals 120 may be greater or fewer. For example, there may be only one terminal 120, or there may be dozens of or hundreds of terminals 120, or even more. The embodiments of this application do not limit the number and device type of the terminal 120.

In the related art, a deep marching tetrahedra (DMTet) method may be used to represent a surface of the 3D entity model with a deformable tetrahedral mesh, converting SDF values into a 3D mesh representation corresponding to the 3D entity model. The DMTet may perform subdivision near the surface of the 3D entity model according to the SDF values.

However, when performing multiple subdivisions of the tetrahedral mesh near the surface of the 3D entity model, sharp and slender tetrahedral meshes are generated, and parts far from the surface may not be merged. Specifically, when the tetrahedral mesh is subdivided many times, the sharp and slender tetrahedral meshes are generated. In two-dimensional diagrams, the sharp and slender tetrahedral meshes are manifested as narrow and elongated triangular patches. Such triangular patches may cause a shape of the 3D mesh to be non-smooth, resulting in erroneous protrusions. However, based on an uneven structure of the tetrahedral mesh, “No Proper” geometry may occur if merging is performed directly, that is, vertices P of some triangular patches may appear on edges of other triangular patches, and when the vertices P are displaced, associated triangular patches may intersect with each other. Because merging and multiple subdivisions are not allowed, erroneous subdivisions caused by inaccurate SDF values at low resolution cannot be corrected, resulting in erroneous clustering of the 3D mesh in regions far from the surface of the 3D entity model.

In the related art, an implicit neural network-based 3D representation method using SDF values (the NeuS method) may alternatively be adopted. This method combines an implicit representation of SDF values with an unbiased volume rendering function. By redefining opacity values to maximize weights precisely on a zero-level set surface of the SDF values, thereby reconstructing an accurate and smooth surface from multi-view images.

However, the foregoing method is essentially a volume rendering-based method, which represents the signed distance field in space using a relatively large multilayer perceptron (MLP). The MLP may express a mapping from a spatial point to the SDF value. Among them, both the volume rendering and the large MLP may lead to slower training and inference speeds. Reconstructing a 3D entity model may take hours, resulting in high time consumption and low efficiency for a reconstruction of the 3D entity model.

The embodiments of this application provide a reconstruction method for a 3D entity model, which may perform voxel subdivision and merging of the 3D entity model based on an octree. This method avoids “No Proper” geometry, ensures that the voxels remain regular cubes even after multiple subdivisions, and densely distributes voxels near a surface of the 3D entity model, allowing for a fine representation of a geometric shape of the surface of the 3D entity model with a small number of voxels. Moreover, the octree may also conveniently maintain a tree structure and parent-child inheritance relationships of the voxels, thereby improving the accuracy of the extracted 3D mesh and facilitating the reconstruction of the 3D entity model.

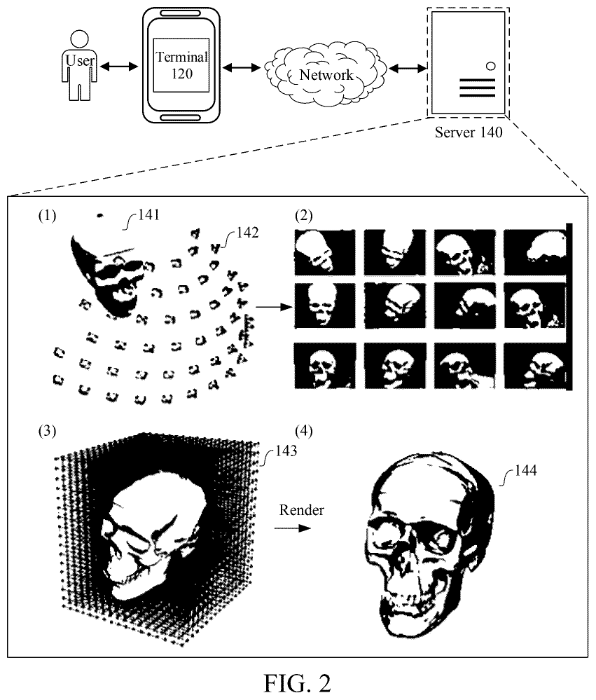

FIG. 2 illustrates a schematic diagram showing a reconstruction method for a 3D entity model according to an exemplary embodiment of this application. The method is executed by a computer device, with the server 140 serving as an example for illustration.

Specifically, as shown in (1) of FIG. 2, a series of images are captured by an image capturing apparatus 142 around a 3D entity model 141. As shown in (2) of FIG. 2, the server 140 obtains a series of images captured around the 3D entity model 141 and capturing attitudes of the image capturing apparatus 142 corresponding to the images. The images carry at least one type of 3D spatial information, such as depth values and point cloud data, thereby enabling the server 140 to obtain the 3D spatial information of the 3D entity model 141. The server 140 performs voxel partitioning on the 3D entity model 141 based on the 3D spatial information to determine voxels 143 corresponding to the 3D entity model 141 and connected in a tree structure. As shown in (3) of FIG. 2, the voxels 143 are distributed on a surface of the 3D entity model 141 and are configured for representing a geometric shape of the surface of the 3D entity model. At positions near the surface of the 3D entity model 141, the voxels 143 are distributed more densely, with smaller volumes and finer granularity. At positions farther from the surface of the 3D entity model 141, the voxels 143 are distributed more sparsely, with larger volumes and coarser granularity.

The server 140 constructs a 3D mesh corresponding to the 3D entity model 141 based on the voxels connected in the tree structure. In some embodiments, the server 140 constructs a dual grid corresponding to the 3D entity model 141 based on dual verts corresponding to the voxels 143. The dual verts are points that have duality with the voxels, and the dual grid is configured for representing the geometric shape of the surface of the 3D entity model 141. The server 140 converts the dual grid to obtain the 3D mesh corresponding to the 3D entity model 141. The 3D mesh is configured for reconstructing the 3D entity model after rendering. As shown in (4) of FIG. 2, a reconstructed 3D entity model 144 has a high degree of similarity and fidelity to an original 3D entity model 141.

In summary, the foregoing solution may extract a 3D mesh with high accuracy and fidelity, thereby enabling accurate reconstruction of the 3D entity model. The foregoing solution may be applied to fields of game rendering, augmented reality (AR), virtual reality (VR), and artificial intelligence generated content (AIGC). For example, a generated 3D mesh may be incorporated as a 3D asset into a game pipeline, and be configured for generating effects such as skinning, rigging, and animation. The 3D mesh may be rendered from any new arbitrary perspective, enabling immersive browsing and experience in AR/VR to enhance user experience.

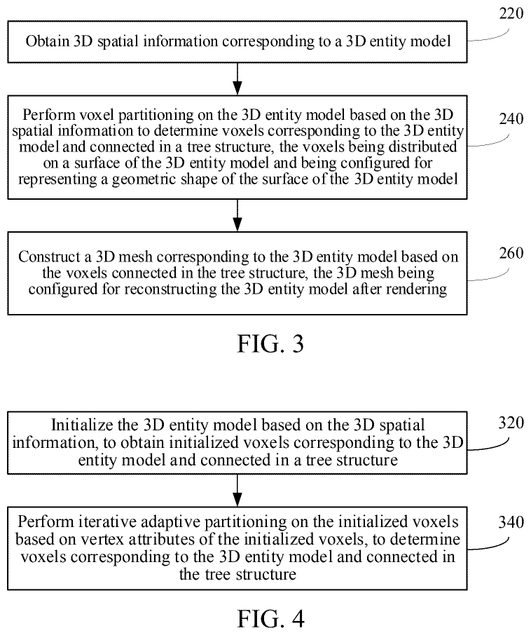

FIG. 3 illustrates a flowchart of a reconstruction method for a 3D entity model according to an exemplary embodiment of this application. The method is implemented on a computer device, which may be the terminal 120 and the server 140 shown in FIG. 1 for illustration. The method includes operation 220, operation 240, and operation 260.

Operation 220: Obtain 3D spatial information corresponding to a 3D entity model.

The 3D entity model refers to a 3D model in a 3D space that needs to be reconstructed.

In some embodiments, the 3D entity model may be a 3D entity in a real world or a fictional 3D entity in a virtual world. For example, the 3D entity model may be at least one of a skull, a torso, a terrain, a building, a virtual skull, a virtual torso, a virtual terrain, or a virtual building.

The 3D spatial information is configured for representing at least one of a geometric shape, a size, a volume, or a color of the 3D entity model in the 3D space.

In some embodiments, the 3D entity model is captured in advance by an image capturing apparatus in various capturing attitudes to obtain a series of images corresponding to the 3D entity model. The images include at least one type of 3D spatial information, such as depth values and point cloud data. A computer device obtains a series of images and capturing attitudes of the image capturing apparatus corresponding to the images, to obtain the 3D spatial information corresponding to the 3D entity model.

In some embodiments, the image capturing apparatus includes various types of depth cameras, 3D cameras, depth camcorders, depth mobile cameras, and so on. In this embodiment, there is no limitation on the type of the image capturing apparatus. The various capturing attitudes include at least one of various capture angles (such as at least one of roll angles, pitch angles, or yaw angles), capture positions (such as at least one of longitude, latitude, or altitude), and capture speeds (such as at least one of longitudinal speed, lateral speed, or vertical speed).

Operation 240: Perform voxel partitioning on the 3D entity model based on the 3D spatial information to determine voxels corresponding to the 3D entity model and connected in a tree structure, the voxels being distributed on a surface of the 3D entity model and being configured for representing a geometric shape of the surface of the 3D entity model.

The voxel refers to a spatial unit obtained by dividing the three-dimensional entity model. For example, the voxel is a cube. In other implementations, the voxel may be realized as other 3D shapes, such as a sphere, a hexagonal prism, or a rectangular prism. In some embodiments, the voxels in the 3D space may achieve space-filling tessellation.

In some embodiments, the computer device performs voxel partitioning on the 3D entity model based on the 3D spatial information using an octree mode, to determine the voxels corresponding to the 3D entity model and connected in the tree structure.

In this embodiment, volumes and distributions of the voxels of the 3D entity model obtained through partitioning are non-uniform. The voxels are densely distributed on the surface of the 3D entity model to represent the geometric shape of the surface of the 3D entity model. The closer to the surface of the 3D entity model, the smaller the volume of the voxels, the more densely distributed, and the finer the granularity. The farther from the surface of the 3D entity model, the larger the volume of the voxels, the less densely distributed, and the coarser the granularity.

In some embodiments, positional relationships between the voxels and the surface of the 3D entity model are determined by SDF values (SDF values) from vertices of the voxels to the nearest surface of the 3D entity model. The SDF values of the vertices of each voxel may be encoded to form a signed distance field. During the voxel partitioning of the 3D entity model, iterative partitioning and optimization may be performed based on the SDF values. This process is briefly described as follows: Perform multiple subdivisions on voxels near the surface of the 3D entity model, and merge voxels far from the surface of the 3D entity model. The merging may correct erroneous subdivisions at low resolution and reduce overhead in regions of less interest. Continue to partition according to the partitioned octree, and after several rounds of partitioning, an octree composed of voxels with different volumes, non-uniform distribution, and concentration on the surface of the 3D entity model may be constructed. The geometric shape of the surface of the 3D entity model may be finely represented using a small number of voxels.

Operation 260: Construct a 3D mesh corresponding to the 3D entity model based on the voxels connected in the tree structure, the 3D mesh being configured for reconstructing the 3D entity model after rendering.

The 3D mesh is a data structure configured for representing the 3D entity model, including a set of points, lines, and surfaces. The 3D mesh is widely used in computer graphics.

Exemplarily, the computer device constructs the 3D mesh corresponding to the 3D entity model based on the voxels connected in the tree structure. Exemplarily, the voxels connected in the tree structure are configured for indicating a presence of at least two different voxel volumes, where voxels with a larger volume may be split into a plurality of voxels with a smaller volume. In the voxels connected in the tree structure, a 3D shape composed of a plurality of voxels with the smaller volume is the same as a 3D shape of a single voxel with the larger volume. Taking the octree as an example, a volume of a parent node equals a sum of volume elements represented by eight child nodes. In other implementations, the parent node may be divided into a greater or fewer number of child nodes.

In summary, the embodiments of this application provide a reconstruction method for a 3D entity model. The method includes: obtaining, by a computer device, 3D spatial information corresponding to a 3D entity model; performing voxel partitioning on the 3D entity model based on the 3D spatial information to determine voxels corresponding to the 3D entity model and connected in a tree structure, the voxels being distributed on a surface of the 3D entity model and being configured for representing a geometric shape of the surface of the 3D entity model; constructing a 3D mesh corresponding to the 3D entity model based on the voxels connected in the tree structure, the 3D mesh being configured for reconstructing the 3D entity model after rendering. Accordingly, by performing voxel partitioning on the 3D entity model, the voxels connected in the tree structure in the 3D mesh may ensure that the voxels always maintain a regular three-dimensional shape. For example, when the voxels are cubes, the voxels in the 3D mesh always maintain regular cubes. Compared with deformable tetrahedral meshes used in the related art, sharp and slender tetrahedral meshes will not appear during subdivision, enabling a smoother geometric shape of a surface of the 3D mesh and preventing a generation of erroneous protrusions. The geometric shape of the surface of the 3D entity model may be accurately and finely represented through the voxels. The method may also be widely applied to fields such as gaming, rendering, AR/VR, 3D reconstruction, 3D-AIGC, 3D point cloud completion, and novel view generation.

The following embodiments provide a detailed description of the operations involved in the reconstruction method for a 3D entity model.

### Adaptive Voxel Partitioning

FIG. 4 illustrates a flowchart of a reconstruction method for a 3D entity model according to an exemplary embodiment of this application. In some embodiments, the foregoing operation 240 may be replaced with operation 320 and operation 340.

Operation 320: Initialize the 3D entity model based on the 3D spatial information, to obtain initialized voxels corresponding to the 3D entity model and connected in a tree structure.

The initialized voxel refers to a voxel obtained by initializing the 3D entity model.

Exemplarily, the 3D entity model is initialized by partitioning it into a low-resolution uniform octree based on the 3D spatial information, to obtain the initialized voxels corresponding to the 3D entity model and connected in the tree structure. The low resolution may be 16 bits or 32 bits. During the initial initialization, the octree has a low resolution, and the initialized voxels are uniform. That is, the initialized voxels have the same volume and are uniformly distributed. As subsequent iterative partitioning continues, the resolution of the octree increases progressively.

Operation 340: Perform iterative adaptive partitioning on the initialized voxels based on vertex attributes of the initialized voxels, to determine the voxels corresponding to the 3D entity model and connected in the tree structure.

The vertex attributes refer to attributes of vertices of the voxels.

In some embodiments, the vertex attributes include SDF values of the vertices, and an SDF value of an i^{th} vertex is represented as si. In some embodiments, the vertex attributes further include one of position coordinates vi and position code fi of the vertex. The position coordinates vi are coordinates in a 3D coordinate system corresponding to the 3D entity model. The SDF value si and the position code fi are optimizable parameters.

In this embodiment, the initialized voxels corresponding to the 3D entity model and connected in the tree structure may be obtained by initializing the 3D entity model. Subsequently, multiple iterative partitions may be performed based on the initialized voxels subsequently, thereby determining the voxels corresponding to the 3D entity model and connected in the tree shape. In addition, such partitioning mode described in this embodiment may alternatively be applied as a plug-in in various optimization methods. For example, the partitioning method may be applied to implicit reconstruction based on 3D point clouds and SDF ground-truth supervision, or to multi-view reconstruction methods based on two-dimensional (2D) image supervision and differentiable rendering.

### Iterative Processing

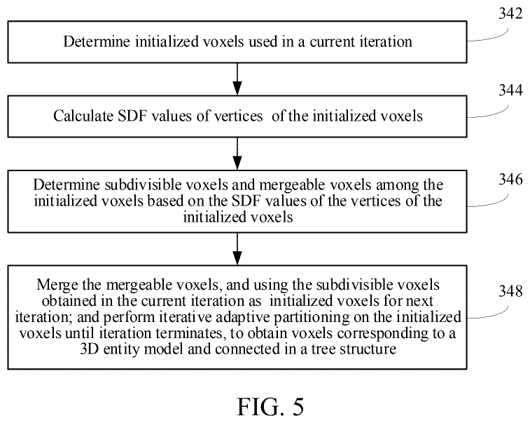

FIG. 5 illustrates a flowchart of a reconstruction method for a 3D entity model according to an exemplary embodiment of this application. In some embodiments, the vertex attributes include the SDF values of the vertices. Specifically, the foregoing operation 340 may be implemented as operation 342, operation 344, operation 346, and operation 348.

Operation 342: Determine the initialized voxels used in a current iteration.

Operation 344: Calculate the SDF values of the vertices of the initialized voxels.

Specifically, since the embodiment uses the octree, each initialized voxel has eight vertices, and the SDF values of the eight vertices of each initialized voxel are calculated.

Operation 346: Determine subdivisible voxels and mergeable voxels among the initialized voxels based on the SDF values of the vertices of the initialized voxels.

The mergeable voxels are those determined in the current iteration that may be merged. The subdivisible voxels are those determined in the current iteration that may be subdivided. The mergeable voxels are determined based on a preset merge threshold, and the subdivisible voxels are determined based on a preset subdivision threshold.

Operation 348: Merge the mergeable voxels, and use the subdivisible voxels obtained in the current iteration as initialized voxels for next iteration; and perform iterative adaptive partitioning on the initialized voxels until iteration terminates, to obtain the voxels corresponding to the 3D entity model and connected in the tree structure.

Specifically, in subsequent iterations, the subdivisible voxel needs to continue to be partitioned, while there is no need to continue partitioning the mergeable voxel. The subdivisible voxels obtained in the current iteration are used as the initialized voxels for the next iteration, and iterative adaptive partitioning continues to be performed on the initialized voxels until a termination condition is satisfied, at which point the iteration terminates and the voxels corresponding to the 3D entity model and connected in the tree structure may be obtained.

In some embodiments, the termination condition for iteration termination includes an update amount of the voxels connected in the tree structure being less than an update amount threshold, or an update error or a pixel error of the voxels connected in the tree structure being less than an error threshold compared to the previous iteration. Exemplarily, by iteratively determining the subdivisible voxels and the mergeable voxels, the 3D shape of the 3D mesh constructed from the voxels approximates that of the 3D entity model, thereby reducing the difference between the 3D mesh and the 3D entity model.

In some embodiments, the computer device determines the SDF values of the vertices by using a multilayer perceptron (MLP). Specifically, the server further determines the position coordinates vi of the vertices of the initialized voxels, and inputs the position coordinates into the MLP to obtain the SDF values of the vertices of the initialized voxels. With continuous iterative partitioning of the voxels, the MLP is also constantly optimized. Since subsequent embodiments mostly focus on determining the SDF values for a small number of subdivisible voxels rather than querying the SDF values for each voxel in a dense 3D space, and since a total number of parameters of the octree+MLP in this embodiment is smaller than that of a large MLP in the NeuS algorithm from the related art, the MLP in the embodiment has a smaller scale, faster training speed, and shorter training time.

Next, the subdivisible voxels and the mergeable voxels in operation 346 are further introduced.

In some embodiments, the subdivisible voxels and the mergeable voxels are determined based on the SDF values of the vertices of the initialized voxels, which are used as a parameter. A sign of the SDF value is configured for representing a positional relationship between the vertex and the surface of the 3D entity model, where a positive sign indicates that the vertex is located inside a shape of the 3D entity model, and a negative sign indicates that the vertex is located outside the shape of the 3D entity model. An absolute value of the SDF value is configured for representing a distance between the vertex and the surface of the 3D entity model. When the distance is 0, it indicates that the vertex is a point on the surface of the 3D entity model. Based on this, the foregoing operation 346 may be specifically implemented as operation 346A, operation 346B, operation 346C, and operation 346D.

Operation 346A: Determine a minimum absolute value among the absolute values corresponding to the SDF values of the vertices of the initialized voxels based on the SDF values of the vertices of the initialized voxels.

In some embodiments, the absolute values corresponding to the SDF values of the vertices of the initialized voxels are determined based on the SDF values of the vertices of the initialized voxels, and a minimum absolute value is determined among the absolute values.

Exemplarily, if the absolute value corresponding to the SDF value of the vertex is the minimum absolute value, it indicates that the vertex is a closest vertex to the surface of the 3D entity model. The vertex may be located outside or inside the shape of the surface of the 3D entity model.

Operation 346B: Determine, when the minimum absolute value is less than a subdivision threshold and there are at least two vertices with SDF values of opposite signs in an initialized voxel including a vertex corresponding to the minimum absolute value, the initialized voxel as the subdivisible voxel.

The subdivision threshold is a preset threshold configured for representing that a voxel may be used as a subdivisible voxel.

In an example, the subdivision threshold may be determined based on at least one of the following factors: the resolution of the octree and a scale of the 3D entity model. Different subdivision thresholds may be set for different 3D entity models. In some embodiments, the subdivision threshold is represented as Tsub.

Exemplarily, when the minimum absolute value is less than the subdivision threshold, it represents that the vertex corresponding to the minimum absolute value is relatively close to the surface of the 3D entity model. Furthermore, when there are at least two vertices with SDF values of opposite signs in the initialized voxel including the vertex corresponding to the minimum absolute value, it represents that the initialized voxel intersects the surface of the 3D entity model, and one part of the initialized voxel is located inside the 3D entity model, and the other part is located outside the 3D entity model. Therefore, the initialized voxel is used as the subdivisible voxel.

In some other embodiments, at least one of the following two conditions described above may be satisfied: the minimum absolute value is less than a subdivision threshold, or there are at least two vertices with SDF values of opposite signs in an initialized voxel including a vertex corresponding to the minimum absolute value.

Specifically, when the minimum absolute value is less than the subdivision threshold, the initialized voxel including the vertex corresponding to the minimum absolute value is determined as the subdivisible voxel. And/or, when there are at least two vertices with the SDF values of opposite signs in the initialized voxel including the vertex corresponding to the minimum absolute value, the initialized voxel is determined as the subdivisible voxel.

In some embodiments, the SDF value of the vertex of the subdivisible voxel satisfies the following formula:

$$( {min}_{i = 1}^{8} \vert {sdf}_{i} \vert < {T}_{s u b} ) \& ( {min}_{i = 1}^{8} \vert sign ( {sdf}_{i} ) \vert * {max}_{i = 1}^{8} \vert sign ( {sdf}_{i} ) \vert \leq 0 )$$

where sdfᵢ represents the SDF value of the i^{th} vertex of the voxel; |sdfᵢ|represents the absolute value corresponding to the SDF value of the i^{th} vertex of the voxel;

$${min}_{i = 1}^{8} \vert {sdf}_{i} \vert$$

represents the minimum absolute value among the absolute values corresponding to the SDF values of the eight vertices of the voxel; T_{sub} represents the subdivision threshold; sign represents the sign; & represents that both conditions are satisfied at the same time; and

$${min}_{i = 1}^{8} \vert sign ( {sdf}_{i} ) \vert * {max}_{i = 1}^{8} \vert sign ( {sdf}_{i} ) \vert \leq 0$$

represents that there are at least two vertices with the SDF values of opposite signs in the voxel.

Operation 346C: Use other initialized voxels, excluding the subdivisible voxels, as non-subdivisible voxels.

Operation 346D: Determine, when an absolute value corresponding to an SDF value of a vertex of the non-subdivisible voxel is greater than a merge threshold, the non-subdivisible voxel as the mergeable voxel.

The merge threshold is a preset threshold configured for representing that a voxel may be used as a mergeable voxel.

In an example, similar to the subdivision threshold, the merge threshold may be determined based on at least one of the following factors: the resolution of the octree and the scale of the 3D entity model. Different merge thresholds may be set for different 3D entity models. In some embodiments, the merge threshold is represented as Tmerge.

In some embodiments, when the absolute value corresponding to the SDF value of the vertex of the non-subdivisible voxel is greater than the merge threshold, the non-subdivisible voxel is determined as the mergeable voxel. The absolute values corresponding to the SDF values of the vertices of the non-subdivisible voxel being greater than the merge threshold may mean either: the absolute values corresponding to the SDF values of at least a portion of the vertices of the non-subdivisible voxel are greater than the merge threshold, or the absolute values corresponding to the SDF value of all the vertices (eight vertices) of the non-subdivisible voxel are greater than the merge threshold.

In some embodiments, when the minimum absolute value corresponding to the SDF value of the vertex of the non-subdivisible voxel is greater than the merge threshold, the non-subdivisible voxel is determined as the mergeable voxel.

In some embodiments, the SDF value of the vertex of the mergeable voxel satisfies the following formula:

$${min}_{i = 1}^{8} \vert {sdf}_{i} \vert > {T}_{m e r g e}$$

where sdfᵢ represents the SDF value of the i^{th} vertex of the voxel; |sdfᵢ| represents the absolute value corresponding to the SDF value of the i^{th} vertex of the voxel;

$${min}_{i = 1}^{8} \vert {sdf}_{i} \vert$$

represents the minimum absolute value among the absolute values corresponding to the SDF values of the eight vertices of the voxel; and T_{merge} represents the merge threshold.

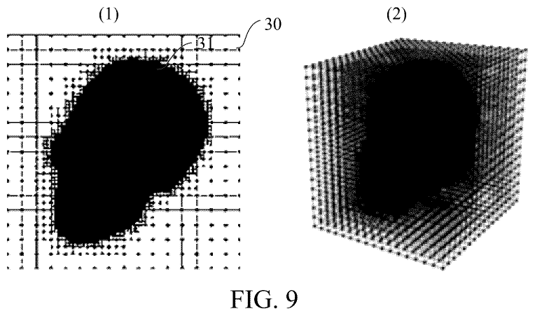

Exemplarily, since the absolute value of the SDF value of the vertex represents the distance between the vertex and the nearest surface, in the embodiment, based on correct SDF values, a schematic diagram showing a voxel distribution of the 3D entity model as shown in FIG. 9 may be obtained. (1) of FIG. 9 is a two-dimensional schematic diagram, in which a grid 30 represents the voxel, and a contour 31 represents the surface of the 3D entity model. (2) of FIG. 9 is a 3D schematic diagram. As can be seen from (1) and (2) of FIG. 9, in the embodiment, the voxels obtained through the iterative partitioning are concentrated near the surface of the 3D entity model, and are non-uniform, so that the geometric shape of the surface of the 3D entity model may be finely represented using fewer voxels and SDF values.

In the foregoing embodiment, a mode for determining whether a voxel is a mergeable voxel or a subdivisible voxel is provided. This facilitates the merging of the mergeable voxels and further fine subdivision of the subdivisible voxels during an iterative partitioning process. Data processing of the computer device may be made to focus on the subdivisible voxels, allowing the voxels to be densely distributed on the surface of the 3D mesh. This facilitates representing the geometric shape of the surface of the 3D entity model with fewer voxels, thereby improving the accuracy and efficiency of determining the 3D mesh.

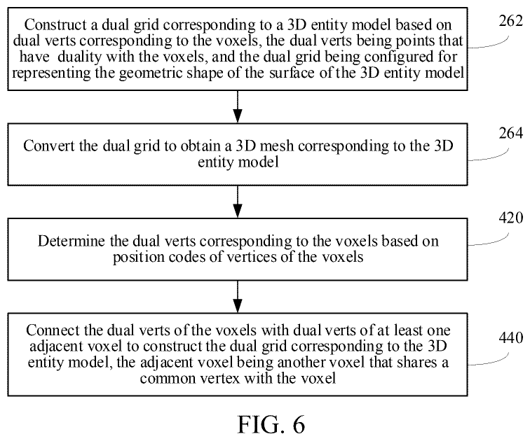

FIG. 6 illustrates a flowchart of a reconstruction method for a 3D entity model according to an exemplary embodiment of this application. In some embodiments, the foregoing operation 260 may be implemented as operation 262 and operation 264.

Operation 262: Construct a dual grid corresponding to the 3D entity model based on dual verts corresponding to the voxels the dual verts being points that have duality with the voxels, and the dual grid being configured for representing the geometric shape of the surface of the 3D entity model.

In the field of mathematical physics, duality refers to a mapping between seemingly different theories that lead to the same physical results. In this embodiment, the dual verts are points that have duality with the voxels. By dualizing from “voxels” to “points,” the dual verts corresponding to the voxels may be obtained.

The dual grid is a grid determined based on the dual verts. In some embodiments, each voxel has a dual vert. A mode for determining the dual verts will be introduced separately below.

Exemplarily, the computer device constructs the dual grid corresponding to the 3D entity model based on the dual verts corresponding to the voxels. The dual grid is configured for representing the geometric shape of the surface of the 3D entity model.

Logically, a mesh structure of the dual grid is definitely a regular grid. For a dual vert in the dual grid, there will always be eight neighboring dual verts in a 3D space (or four neighboring dual verts in a two-dimensional space), among which the eight neighboring dual verts may include overlapping dual verts.

Operation 264: Convert the dual grid to obtain the 3D mesh corresponding to the 3D entity model.

The 3D mesh is a data structure configured for representing the 3D entity model, including a set of points, lines, and surfaces. The 3D mesh is widely used in computer graphics.

In some embodiments, the computer device converts the dual grid, to obtain the 3D mesh corresponding to the 3D entity model. The 3D mesh is configured for reconstructing the 3D entity model after rendering.

In some embodiments, a mode for converting the dual grid includes at least one of an MC algorithm or a Lewiner marching cubes algorithm (MC33 algorithm), which may be selected according to the actual technical requirements.

In this embodiment, the dual grid corresponding to the 3D entity model is constructed based on the dual verts corresponding to the voxels, and the dual grid is converted to obtain the 3D mesh corresponding to the 3D entity model. The process is differentiable, which allows an extracted 3D mesh to be more accurate.

### Construction of a Dual Grid

In some embodiments, after determining the voxels of the 3D entity model, the computer device needs to extract a mesh structure, and then the computer device may generate a 3D mesh corresponding to the 3D entity model based on the mesh structure. In some embodiments, the foregoing operation 262 may be replaced with operation 420 and operation 440.

Operation 420: Determine the dual verts corresponding to the voxels based on position codes of vertices of the voxels.

In this embodiment, based on the tree structure of the octree, the vertices of the voxels naturally possess a multi-level parent-child relationship. The position code of a vertex refers to the code of the vertex of the voxel that represents the vertex's position, level, and multi-level parent-child relationships with other voxels in the octree structure.

The dual vert is a point obtained by dualizing a “voxel” to a “point.” In some embodiments, each voxel corresponds to a dual vert. Since there is duality between the dual vert and the voxel, they lead to the same physical results. Therefore, a voxel, which has volume, is represented by a dual vert that has no volume. The dual vert of the voxel is a point that represents the voxel.

The following embodiments illustrate two modes for determining the dual vert, which may be used individually or in combination in practical applications.

### Mode 1 for Determining the Dual Vert

In some embodiments, the foregoing operation 420 may be implemented as operation 421 and operation 422.

Operation 421: Determine voxel center points of the voxels based on the position codes of the vertices of the voxels.

Operation 422: Determine the voxel center points of the voxels as the dual verts corresponding to the voxels.

In some embodiments, based on the position codes of the vertices of the voxels, internal vertices, i.e., the voxel center points of the voxels, are extracted from each voxel. The voxel center points of the voxels are determined as the dual verts corresponding to the voxels. From a perspective of 3D space, the center point of the voxel in the 3D space is determined as the dual vert that may be configured for representing the voxel. The dual vert represents the position of the voxel in the 3D space.

### Mode 2 for Determining the Dual Vert

In some embodiments, the foregoing operation 420 may be implemented as operation 423 and operation 424.

Operation 423: Perform an interpolation operation on the SDF values of the vertices of the voxels based on the position codes of the vertices of the voxels, to obtain interpolation operation points of the voxels.

Operation 424: Determine the interpolation operation points of the voxels as the dual verts corresponding to the voxels.

The interpolation operation point is a point predicted through the interpolation operation.

In some embodiments, the interpolation operation includes at least one of nearest neighbor interpolation, bilinear interpolation, or 3D linear interpolation. Exemplarily, the interpolation operation is performed on the SDF values of the vertices of the voxels based on the position codes of the vertices of the voxels to obtain the interpolation operation points of the voxels, and the interpolation operation point for the voxels are determined as the dual verts corresponding to the voxels. From a perspective of the 3D entity model, a signed distance between the vertex of the voxel and the 3D entity model may represent the positional relationship between the vertex and the 3D entity model (for example, whether the vertex is located inside or outside the 3D entity model, and the distance between the vertex and the 3D entity model). An interpolation result of the signed distance between the vertex of the voxel and the 3D entity model is determined as the dual vert, which may represent the positional relationship between the voxel and the 3D entity model.

Operation 440: Connect the dual verts of the voxels with dual verts of at least one adjacent voxel to construct the dual grid corresponding to the 3D entity model, the adjacent voxel being another voxel that shares a common vertex with the voxel.

When two voxels share a common vertex, the two voxels are referred to as adjacent voxels. That is, an adjacent voxel of a voxel is another voxel that shares a common vertex with the voxel. In this embodiment, each voxel has at least one adjacent voxel. Since the octree is used in this embodiment, a voxel may have up to eight adjacent voxels.

The dual grid is a mesh structure formed by connecting the dual verts.

In some embodiments, the computer device connects the dual verts of the voxels with the dual verts of at least one adjacent voxel to construct the dual grid corresponding to the 3D entity model.

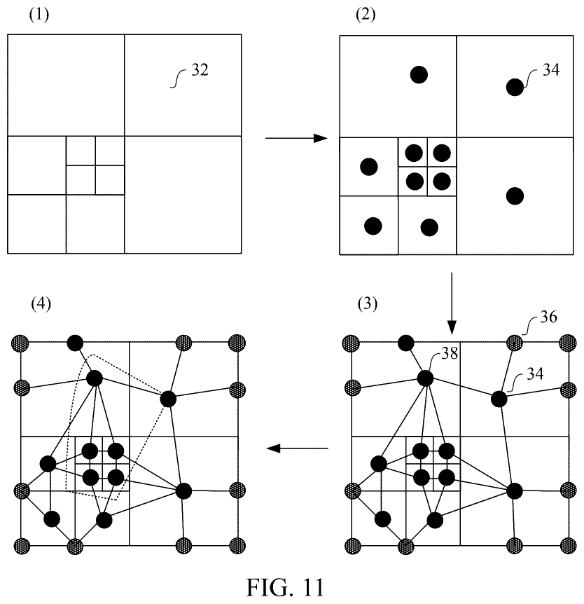

As an example, FIG. 11 illustrates a schematic diagram showing a reconstruction method for a 3D entity model according to an exemplary embodiment of this application. As shown in a two-dimensional schematic voxel diagram in (1) of FIG. 11, each square 32 represents a voxel. In this embodiment, due to non-uniform subdivision granularity of the voxels, there are not necessarily eight voxels adjacent to the vertex on the octree. Correspondingly, in the two-dimensional schematic diagram, there are not necessarily four voxels adjacent to the vertex. Therefore, in this embodiment, the internal vertices are extracted from each voxel of the octree. These internal vertices form a dual vert 34 as shown in (2) of FIG. 11, with each voxel requiring only one dual vert 34. As shown in (3) of FIG. 11, the dual vert 34 is connected to its adjacent voxels' dual verts, such as dual vert 36 and dual vert 38, forming a dual grid as shown in (3) of FIG. 11. The dual grid is always a regular grid, where each dual vert logically has eight adjacent dual verts, which may include overlapping dual verts.

The foregoing embodiments provide various modes for determining the dual vert, enhancing the flexibility of dual vert determination. In the foregoing embodiments, the dual grid corresponding to the 3D entity model may also be constructed, making the subsequent process of extracting the 3D mesh differentiable and thereby improving the accuracy of the 3D mesh.

### Position Code of the Vertex

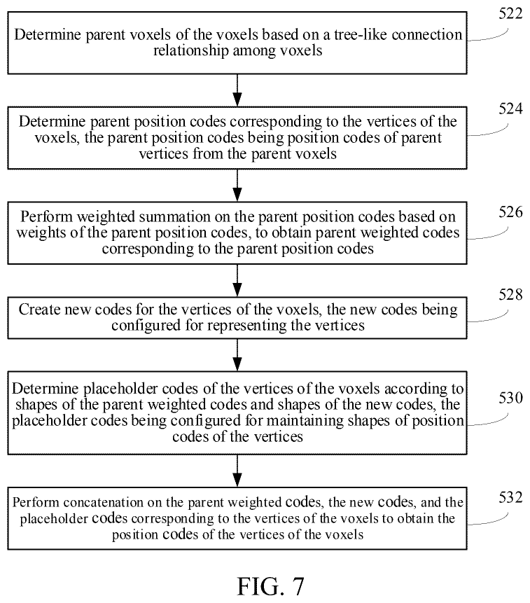

In some embodiments, FIG. 7 illustrates a flowchart of a reconstruction method for a 3D entity model according to an exemplary embodiment of this application. Before operation 420, it is also necessary to determine position codes of the vertices of the voxels to subsequently determine the dual verts. The method further includes operation 522, operation 524, operation 526, operation 528, operation 530, and operation 532.

Operation 522: Determine parent voxels of the voxels based on a tree-like connection relationship among the voxels.

The tree-like connection relationship refers to a multi-layer parent-child relationship of the voxels in a tree structure of the octree.

The parent voxel is the voxel in an upper level that has a parent-child relationship with a voxel in the current level.

In some embodiments, the computer device determines the parent voxels of the voxels based on the tree-like connection relationship among the voxels.

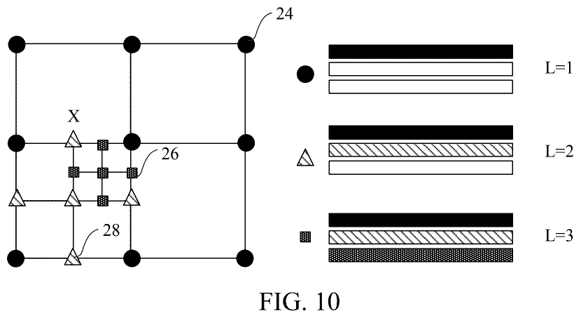

FIG. 10 illustrates a schematic diagram showing position code based on an octree according to an exemplary embodiment of this application. FIG. 10 is a two-dimensional schematic diagram of an octree. The octree includes three levels. In the two-dimensional schematic diagram, the “octree” is shown as a “quadtree.” The voxels partitioned in the first level have vertices represented by circles 24. When the voxel in the bottom-right corner of the first level is further partitioned in the second level, the vertices of the resulting voxels are represented by triangles 28. Subsequently, when the voxel in the top-right corner of the second level is partitioned in the third level, the vertices of the resulting voxels are represented by squares 26. There is a parent-child relationship among the three levels of voxels. Taking the vertex X of a voxel in the second level in the two-dimensional schematic diagram of FIG. 10 as an example, for the vertex X, the voxels partitioned in the first level are all parent voxels of the vertex X; and all voxels in the second level corresponding to the vertex X may serve as parent voxels corresponding to the vertices of the voxels partitioned in the next level.

Operation 524: Determine parent position codes corresponding to the vertices of the voxels, the parent position codes being position codes of parent vertices from the parent voxels.

The parent position code is a position code corresponding to the parent vertex.

Exemplarily, the computer device determines the parent position codes corresponding to the vertices of the voxels and the parent position codes are position codes of the parent vertices from the parent voxels. A vertex of the voxel has up to eight parent vertices. A parent position code of an i^{th} parent vertex of a vertex is represented as

$${f}_{i}^{l - 1} .$$

Operation 526: Perform weighted summation on the parent position codes based on weights of the parent position codes, to obtain parent weighted codes corresponding to the parent position codes.

In some embodiments, the weight of the parent position code may be a value determined based on the SDF value of the parent vertex, or a learnable quantity, or a custom value. A weight of the parent position code of the i^{th} parent vertex of a vertex is represented as

$${ω}_{i}^{l - 1} .$$

The parent weighted code is represented as f̅^̅{̅l̅-̅1̅}̅.

Exemplarily, the computer device performs the weighted summation on the parent position codes based on the weights of the parent position codes, to obtain the parent weighted codes corresponding to the parent position codes.

Operation 528: Create new codes for the vertices of the voxels, the new codes being configured for representing the vertices.

The new code is a code configured for representing the vertex that needs to be expressed in this instance. The new code is represented as [symbol] .

Exemplarily, the computer device creates the new codes for the vertices of the voxels, and the new codes are configured for representing the vertices.

Operation 530: Determine placeholder codes of the vertices of the voxels according to shapes of the parent weighted codes and shapes of the new codes, the placeholder codes being configured for maintaining shapes of the position codes of the vertices.

In some embodiments, a value of the placeholder code is 0. The placeholder code is placed at the extreme end of the position code of the vertex, and the placeholder code is configured for maintaining the shape of the position code of the vertex. Exemplarily, in this embodiment, the shape of the position code of the vertex at each level is set as the product of a number of levels L and a level code dimension M.

Exemplarily, the computer device determines the placeholder codes of the vertices of the voxels according to the shapes of the parent weighted codes and the shapes of the new codes.

Operation 532: Perform concatenation on the parent weighted codes, the new codes, and the placeholder codes corresponding to the vertices of the voxels to obtain the position codes of the vertices of the voxels.

In some embodiments, the computer device uses a concatenate function (Cat) to concatenate the parent weighted codes, the new codes, and the placeholder codes of the vertices of the voxels, thereby obtaining the position codes of the vertices of the voxels. A position code corresponding to a vertex may be represented as f^{l}.

As an example, taking the two-dimensional schematic diagram of an octree with a three-layer structure shown in FIG. 10 as an example, for a vertex of a voxel in a given level, the position code of the vertex is obtained by superimposing the parent weighted codes f̅¹̅, f̅²̅, . . . , and f̅^̅{̅l̅-̅1̅}̅, its own new code [symbol] , and the placeholder code. Exemplarily, the parent weighted code f̅^̅{̅l̅-̅1̅}̅ corresponding to a parent vertex of the vertex is represented as follows:

$$\overline{{f}^{l - 1}} = {\sum }_{i}^{8} {ω}_{i}^{l - 1} * {f}_{i}^{l - 1}$$

where f̅^̅{̅l̅-̅1̅}̅ is derived from a weighted sum of the position codes of the vertices of the parent voxel of the voxel, and weight w may be the SDF value, the learnable quantity, or the custom value of the vertex. Taking the position code of a vertex X represented by a triangle in the second level in FIG. 10 as an example, the parent weighted code of the vertex X is derived from the weighted sum of the parent vertices represented by circles in the first level. Meanwhile, the new codes are created for the vertices represented by triangles in the second level. To keep the code shape of each level as L (number of levels) x M (level code dimension), placeholder codes (all set to zero) are appended at the end. Accordingly, the position code of each vertex retains a multi-level parent association relationship, constructing a smooth spatial feature. Generally, the position code of a vertex at a given level of the octree is represented as follows:

$${f}^{l} = Cat ( \overline{{f}^{1}} , … , \overline{{f}^{l - 1}} , \hat{{f}^{l}} , {0}^{l + 1} , … , {0}^{l} ) .$$

In this embodiment, multi-level position codes may be conveniently provided for the vertices of each voxel based on the octree. This facilitates the construction of the smooth spatial feature, thereby improving the accuracy of the 3D mesh.

### Extraction of the 3D Mesh

In some embodiments, the foregoing operation 264 is specifically implemented as follows: The computer device performs mapping to obtain an isosurface of the dual grid based on SDF values of grid vertices in the dual grid using an MC algorithm, and generates the 3D mesh corresponding to the 3D entity model based on the isosurface of the dual grid.

In some embodiments, the MC algorithm in this embodiment is an MC33 algorithm. Specifically, the computer device performs mapping to obtain the isosurface of the dual grid based on positive or negative signs of the SDF values of grid vertices in the dual grid using the MC33 algorithm, where points on the isosurface correspond to the SDF values of zero. The 3D mesh corresponding to the 3D entity model may be generated based on the isosurface of the dual grid. In some examples, the 3D mesh may further incorporate voxel center points and/or interpolation operation points as supplementary points, resulting in a higher-density 3D mesh.

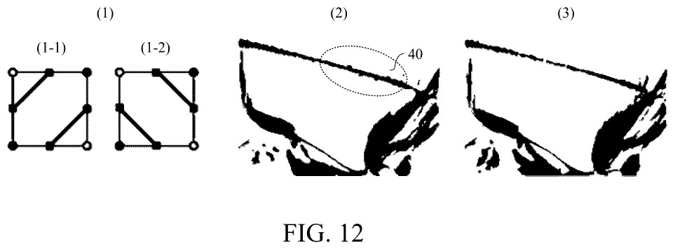

In an MC algorithm of a related technology, when extracting the 3D mesh, it is required to perform the extraction based on a regular grid, where each vertex is adjacent to eight voxels. However, in this embodiment, the dual grid is processed. As an example, FIG. 12 illustrates a schematic diagram of a reconstruction method for a 3D entity model according to an exemplary embodiment of this application. (1-1) and (1-2) shown in (1) of FIG. 12 illustrate two surface splitting modes in the MC algorithm of the related technology, where black points/white points represent the vertices with positive/negative SDF values, respectively. Due to the existence of the two surface splitting modes, the extracted 3D mesh may exhibit geometric holes 40 as shown in (2) of FIG. 12. Therefore, this embodiment provides a differentiable dual marching cubes (MC) method, which uses the MC33 algorithm to process the dual grid and extract the 3D mesh corresponding to the dual grid. The two-dimensional schematic diagram of the extracted 3D mesh is shown in (4) of FIG. 11, and the three-dimensional schematic diagrams of the 3D mesh are shown in (3) of FIGS. 2 and (3) of FIG. 12. The 3D mesh does not exhibit the geometric holes 40 as shown in (2) of FIG. 12, ensuring topological correctness and manifoldness of the 3D mesh.

The 3D mesh extracted in this embodiment may effectively avoid the generation of geometric holes, ensuring the topological correctness and manifoldness of the 3D mesh.

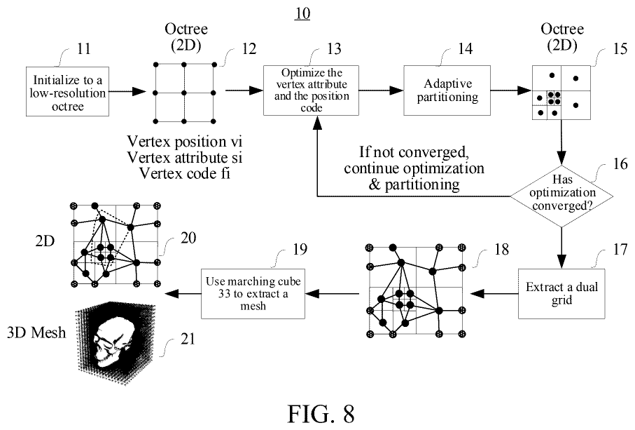

The following explanation of the reconstruction method for a 3D entity model provided in this embodiment is given in conjunction with an overall framework diagram. FIG. 8 illustrates an overall framework diagram of a reconstruction method for a 3D entity model according to an exemplary embodiment of this application. The overall framework diagram 10 may be briefly described as follows:

3D spatial information of the 3D entity model is initialized 11 by partitioning it into a low-resolution (e.g., 16/32) uniform octree. The initialized uniform octree is shown as a two-dimensional schematic diagram 12, and an initial vertex position vi, a vertex attribute si, and a position code fi of a vertex of each voxel in the octree are determined. The vertex attribute si and the position code fi are both optimizable network parameters 13. Adaptive partitioning 14 is performed according to the vertex attribute si. For each voxel, SDF values of its 8 vertices are calculated. When a minimum absolute SDF value is less than a subdivision threshold Tsub and there are at least two vertices with SDF values of opposite signs, the voxel is determined as a subdivisible voxel. Among non-subdivisible voxels (excluding the subdivisible voxels), the voxels whose absolute SDF values of all 8 vertices are greater than a merge threshold Tmerge are selected and determined as mergeable voxels. The octree is uniformly subdivided and merged based on the mergeable voxels and the subdivisible voxels, and the processed octree is shown as a two-dimensional schematic diagram 15. After each adaptive partitioning, the vertex position vi, vertex attribute si, and position code fi of each vertex are re-assigned according to the new octree. Whether convergence 16 has been achieved after this round of processing is determined. If the convergence has not been achieved, a new round of optimization is performed. The cycle of optimization and partitioning is repeated multiple times until the overall optimization converges.

After optimization convergence, the differentiable dual MC method is used to extract a dual grid 17 according to the voxels obtained through partitioning. In a related technology, MC algorithm requires an input structure to be a regular grid, where each vertex is adjacent to eight cubes. However, in this embodiment, due to non-uniform subdivision granularity of the voxels, there are not necessarily eight cubes adjacent to each vertex. Therefore, in this embodiment, internal vertices are extracted from each voxel. The internal vertices may be voxel center points or may be obtained by performing interpolation operation using the SDF values of the vertices of the voxel. The internal vertices form dual verts corresponding to the voxel. The MC algorithm places the vertices on edges of each cube. In contrast, the dual MC method in this embodiment places the vertices inside each voxel. Each voxel requires only one dual vert. By connecting the dual vert to dual verts of its adjacent voxels, a dual grid is formed. The dual grid is always a regular grid, where each dual vert logically has eight adjacent dual verts, which may include overlapping dual verts. The dual grid is shown as a two-dimensional schematic diagram 18. Then, a 3D mesh 19 corresponding to the dual grid is extracted using an MC33 algorithm. The 3D mesh is shown as a two-dimensional schematic diagram 20 and a 3D schematic diagram 21.

In summary, the reconstruction method for a 3D entity model provided in this embodiment has at least the following beneficial effects:

1. Based on a flexible voxel partitioning mode, voxels in an octree are concentrated near a surface of a 3D entity model, allowing a fine shape of the 3D entity model to be represented with fewer voxels. This enables an inference of SDF values to be performed only near the surface, rather than throughout a dense 3D space, thereby accelerating data processing.

2. The voxels are partitioned based on the octree, facilitating the provision of multi-level position codes for vertices of the voxels and thereby constructing a smooth spatial feature.

3. A dual vert and a dual grid are extracted based on the voxels obtained by partitioning the octree, and then a 3D mesh is extracted. This process is differentiable and may be widely applied to model reconstruction based on differentiable rendering.

4. A representation mode of a 3D mesh provided in this embodiment may be widely applied as a plug-in in fields such as games, rendering, AR/VR, 3D reconstruction, 3D-AIGC, 3D point cloud completion, and novel view generation.

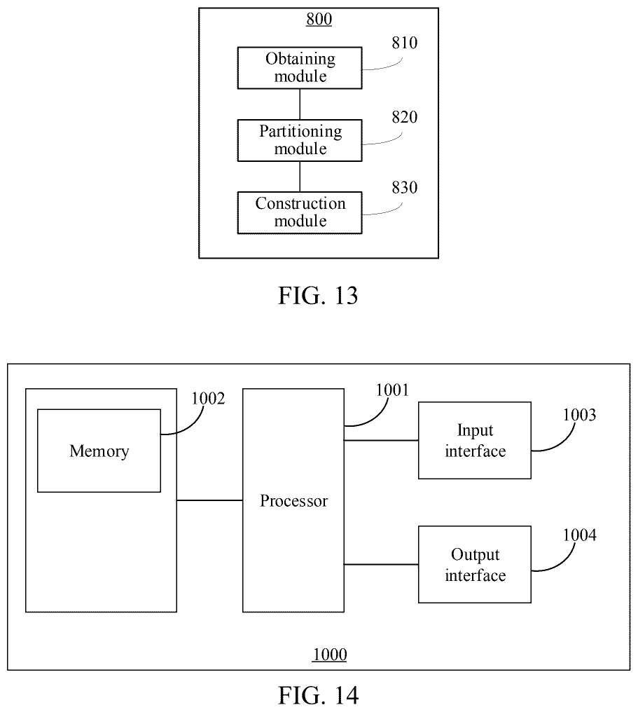

FIG. 13 illustrates a block diagram of a reconstruction apparatus 800 for a 3D entity model provided by an exemplary embodiment of this application. The reconstruction apparatus 800 for the 3D entity model includes:
an obtaining module 810, configured to perform operation 220 in the embodiment of FIG. 3;
a partitioning module 820, configured to perform operation 240 in the embodiment of FIG. 3; and
a construction module 830, configured to perform operation 260 in the embodiment of FIG. 3.

In some embodiments, the partitioning module 820 is configured to perform operation 320 and operation 340 in the embodiment of FIG. 4.

In some embodiments, the vertex attributes include the SDF values of the vertices.

In some embodiments, the partitioning module 820 is configured to perform operation 342, operation 344, operation 346, and operation 348 in the embodiment of FIG. 5.

In some embodiments, signs of the SDF values are configured for representing positional relationships between the vertices and the surface of the 3D entity model, and absolute values of the SDF values are configured for representing distances between the vertices and the surface of the 3D entity model.

In some embodiments, the partitioning module 820 is configured to: determine a minimum absolute value among the absolute values corresponding to the SDF values of the vertices of the initialized voxels based on the SDF values of the vertices of the initialized voxels;
determine, when the minimum absolute value is less than a subdivision threshold and there are at least two vertices with SDF values of opposite signs in an initialized voxel including a vertex corresponding to the minimum absolute value, the initialized voxel as the subdivisible voxel;
use other initialized voxels, excluding the subdivisible voxels, as non-subdivisible voxels; and
determine, when an absolute value corresponding to an SDF value of a vertex of the non-subdivisible voxel is greater than a merge threshold, the non-subdivisible voxel as the mergeable voxel.

In some embodiments, the apparatus further includes a processing module. The processing module is configured to:
determine position coordinates of the vertices of the initialized voxels; and
input the position coordinates into a multilayer perceptron to obtain the SDF values of the vertices of the initialized voxels.

In some embodiments, the construction module 830 is configured to perform operation 262 and operation 264 in the embodiment of FIG. 6.

In some embodiments, the construction module 830 is configured to perform operation 420 and operation 440 in the embodiment of FIG. 6.

In some embodiments, the construction module 830 is configured to:
determine voxel center points of the voxels based on the position codes of the vertices of the voxels; and
determine the voxel center points of the voxels as the dual verts corresponding to the voxels.

In some embodiments, the construction module 830 is configured to: perform an interpolation operation on the SDF values of the vertices of the voxels based on the position codes of the vertices of the voxels, to obtain interpolation operation points of the voxels; and

determine the interpolation operation points of the voxels as the dual verts corresponding to the voxels.

In some embodiments, the apparatus further includes a processing module. The processing module is configured to perform operation 522 to operation 532 in the embodiment of FIG. 7.

In some embodiments, the construction module 830 is configured to: perform mapping to obtain an isosurface of the dual grid based on SDF values of grid vertices in the dual grid using an MC algorithm; and generate the 3D mesh corresponding to the 3D entity model based on the isosurface of the dual grid.

For specific limitations in one or more embodiments of the foregoing provided reconstruction apparatus 800 for the 3D entity model, refer to the foregoing limitations on the reconstruction method for 3D entity model. Details are not described herein again. The modules of the foregoing apparatus may be all or partially implemented by software, hardware, and a combination thereof. The modules may be embedded in or independent of a processor of a computer device in the form of hardware, or may be stored in a memory of the computer device in the form of software, so that the processor invokes them to perform operations corresponding to the modules.

The embodiments of this application further provide a computer device, including a processor and a memory, the memory having a computer program stored therein, the processor being configured to execute the computer program in the memory to implement the reconstruction method for a 3D entity model provided in the foregoing method embodiments.

Exemplarily, FIG. 14 is a structural block diagram of a computer device 1000 according to an exemplary embodiment of this application. In some embodiments, the computer device 1000 is a server 1000.

Generally, the server 1000 includes a processor 1001 and a memory 1002.

The processor 1001 may include one or more processing cores, for example, a 4-core processor or an 8-core processor. The processor 1001 may be implemented in at least one of the following hardware forms: a digital signal processor (DSP), a field-programmable gate array (FPGA), and a programmable logic array (PLA). The processor 1001 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1001 may be integrated with a graphics processing unit (GPU). The GPU is configured to render and draw content that needs to be displayed on a display. In some embodiments, the processor 1001 further includes an artificial intelligence (AI) processor. The AI processor is configured to process a computing operation related to machine learning.

The memory 1002 may include one or more computer-readable storage media. The computer-readable storage medium may be non-transient. The memory 1002 may further include a high-speed random access memory and a non-volatile memory, for example, one or more disk storage devices or flash storage devices. In some embodiments, a non-transient computer-readable storage medium in the memory 1002 is configured to store at least one instruction, and the at least one instruction is configured to be executed by the processor 1001 to implement the reconstruction method for a 3D entity model provided in the method embodiments of this application.

In some embodiments, the server 1000 may alternatively include: an input interface 1003 and an output interface 1004. The processor 1001, the memory 1002, the input interface 1003, and the output interface 1004 may be connected through a bus or a signal line. Each peripheral device may be connected to the input interface 1003 and the output interface 1004 through a bus, a signal line, or a circuit board. The input interface 1003 and the output interface 1004 may be configured to connect at least one peripheral device related to input/output (I/O) to the processor 1001 and the memory 1002. In some embodiments, the processor 1001, the memory 1002, the input interface 1003, and the output interface 1004 are integrated on a same chip or circuit board. In some other embodiments, any one or two of the processor 1001, the memory 1002, the input interface 1003, and the output interface 1004 may be implemented on a single chip or circuit board. This is not limited in the embodiments of this application.

A person skilled in the art may understand that the structure shown in FIG. 14 does not constitute any limitation on the computer device 1000, and the computer device 1000 may include more components or fewer components than those shown in the figure, or some components may be combined, or a different component deployment may be used.

In an exemplary embodiment, this application provides a chip. The chip includes a programmable logic circuit and/or program instructions. When the chip runs on a computer device, the chip is configured to implement the reconstruction method for a 3D entity model provided in the foregoing method embodiments.

This application provides a computer-readable storage medium. The computer-readable storage medium has a computer program stored thereon, and the computer program is loaded and executed by a processor to implement the reconstruction method for a 3D entity model provided in the foregoing method embodiments.

This application provides a computer program product or a computer program. The computer program product or the computer program includes computer instructions, and the computer instructions are stored in a computer-readable storage medium. A processor of a computer device reads the computer instructions from the computer-readable storage medium, and executes the computer instructions, so that the processor of the computer device loads and executes the computer instructions to implement the reconstruction method for a 3D entity model provided in the foregoing method embodiments.

The sequence numbers of the foregoing embodiments of this application are merely for description purposes but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The foregoing computer-readable storage medium may be a read-only memory, a magnetic disk, an optical disc, or the like.

A person skilled in the art may be aware that in the foregoing one or more examples, functions described in embodiments of this application may be implemented by using hardware, software, firmware, or any combination thereof. When implemented by using software, the functions may be stored in a computer-readable medium or may be used as one or more instructions or code in a computer-readable medium for transferring. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely some embodiments of this application, but are not intended to limit this application. Any modification, equivalent replacement, or improvement made within the spirit and principle of this application shall fall within the scope of this application.

What is claimed is:

1. A three-dimensional (3D) entity model reconstruction method, performed by a computer device, comprising:
obtaining 3D spatial information corresponding to a 3D entity model;
performing voxel partitioning on the 3D entity model based on the 3D spatial information to determine voxels corresponding to the 3D entity model and connected in a tree structure, the voxels being distributed on a surface of the 3D entity model and representing a geometric shape of the surface of the 3D entity model; and
constructing a 3D mesh corresponding to the 3D entity model based on the voxels.

2. The method according to claim 1, wherein performing voxel partitioning on the 3D entity model includes:
initializing the 3D entity model based on the 3D spatial information, to obtain initialized voxels corresponding to the 3D entity model and connected in a tree structure; and
performing iterative adaptive partitioning on the initialized voxels based on vertex attributes of the initialized voxels, to determine the voxels corresponding to the 3D entity model and connected in the tree structure.

3. The method according to claim 2, wherein:
a vertex attribute includes a signed distance field (SDF) value of a vertex; and
performing iterative adaptive partitioning on the initialized voxels includes, in each iteration:
determining the initialized voxels used in the iteration;
calculating SDF values of vertices of the initialized voxels;
determining subdivisible voxels and mergeable voxels among the initialized voxels based on the SDF values of the vertices of the initialized voxels; and
merging the mergeable voxels, and using the subdivisible voxels as initialized voxels in a next iteration to continue performing iterative adaptive partitioning until iteration terminates, to obtain the voxels corresponding to the 3D entity model and connected in the tree structure.

4. The method according to claim 3, wherein:
a sign of an SDF value of a vertex represents a positional relationship between the vertex and the surface of the 3D entity model, and an absolute value of the SDF value of the vertex represents a distance between the vertex and the surface of the 3D entity model; and
determining the subdivisible voxels and mergeable voxels includes:
determining a minimum absolute value among the absolute values corresponding to the SDF values of the vertices of the initialized voxels;
in response to the minimum absolute value being less than a subdivision threshold and at least two vertices with SDF values of opposite signs existing in an initialized voxel that includes a vertex corresponding to the minimum absolute value, determining the initialized voxel as a subdivisible voxel;
determining other initialized voxels, other than the subdivisible voxels, as non-subdivisible voxels; and
in response to an absolute value corresponding to an SDF value of a vertex of a non-subdivisible voxel being greater than a merge threshold, determining the non-subdivisible voxel as a mergeable voxel.

5. The method according to claim 3, further comprising:
determining position coordinates of the vertices of the initialized voxels; and
inputting the position coordinates into a multilayer perceptron to obtain the SDF values of the vertices of the initialized voxels.

6. The method according to claim 1, wherein constructing the 3D mesh includes:
constructing a dual grid corresponding to the 3D entity model based on dual verts corresponding to the voxels, each of the dual verts being a point that has duality with one of the voxels, and the dual grid representing the geometric shape of the surface of the 3D entity model; and
converting the dual grid to obtain the 3D mesh corresponding to the 3D entity model.

7. The method according to claim 6, wherein constructing the dual grid includes:
determining the dual verts corresponding to the voxels based on position codes of vertices of the voxels; and
connecting the dual vert of a first voxel with the dual vert of each of at least one second voxel adjacent to the first voxel to construct the dual grid corresponding to the 3D entity model, each of the at least one second voxel sharing a common vertex with the first voxel.

8. The method according to claim 7, wherein determining the dual verts includes, for each voxel of the voxels:
determining a voxel center point of the voxel based on the position codes of the vertices of the voxel; and
determining the voxel center point as the dual vert corresponding to the voxel.

9. The method according to claim 7, wherein determining the dual verts includes, for each voxel of the voxels:
performing an interpolation operation on signed distance field (SDF) values of vertices of the voxel based on the position codes of the vertices of the voxel, to obtain an interpolation operation point of the voxel; and
determining the interpolation operation point as the dual vert corresponding to the voxel.

10. The method according to claim 6, further comprising:
determining parent voxels of the voxels based on a tree-like connection relationship among the voxels;
determining parent position codes corresponding to the vertices of the voxels, the parent position codes being position codes of parent vertices from the parent voxels;
performing weighted summation on the parent position codes based on weights of the parent position codes, to obtain parent weighted codes corresponding to the parent position codes;
creating new codes for the vertices of the voxels, the new codes representing the vertices;
determining placeholder codes of the vertices of the voxels according to shapes of the parent weighted codes and shapes of the new codes, the placeholder codes being configured for maintaining shapes of the position codes of the vertices; and
performing concatenation on the parent weighted codes, the new codes, and the placeholder codes corresponding to the vertices of the voxels to obtain the position codes of the vertices of the voxels.

11. The method according to claim 6, wherein converting the dual grid includes:
performing mapping to obtain an isosurface of the dual grid based on signed distance field (SDF) values of grid vertices in the dual grid using a marching cubes algorithm; and
generating the 3D mesh corresponding to the 3D entity model based on the isosurface of the dual grid.

12. A computer device comprising:
a processor; and
a memory storing a computer program that, when executed by the processor, causes the computer device to:
obtain 3D spatial information corresponding to a 3D entity model;
perform voxel partitioning on the 3D entity model based on the 3D spatial information to determine voxels corresponding to the 3D entity model and connected in a tree structure, the voxels being distributed on a surface of the 3D entity model and representing a geometric shape of the surface of the 3D entity model; and
construct a 3D mesh corresponding to the 3D entity model based on the voxels.

13. The computer device according to claim 12, wherein the computer program, when executed by the processor, further causes the computer device to, when performing voxel partitioning on the 3D entity model:
initialize the 3D entity model based on the 3D spatial information, to obtain initialized voxels corresponding to the 3D entity model and connected in a tree structure; and
perform iterative adaptive partitioning on the initialized voxels based on vertex attributes of the initialized voxels, to determine the voxels corresponding to the 3D entity model and connected in the tree structure.

14. The computer device according to claim 13, wherein:
a vertex attribute includes a signed distance field (SDF) value of a vertex; and
the computer program, when executed by the processor, further causes the computer device to, when performing iterative adaptive partitioning on the initialized voxels, in each iteration:
determine the initialized voxels used in the iteration;
calculate SDF values of vertices of the initialized voxels;
determine subdivisible voxels and mergeable voxels among the initialized voxels based on the SDF values of the vertices of the initialized voxels; and
merge the mergeable voxels, and use the subdivisible voxels as initialized voxels in a next iteration to continue performing iterative adaptive partitioning until iteration terminates, to obtain the voxels corresponding to the 3D entity model and connected in the tree structure.

15. The computer device according to claim 14, wherein:
a sign of an SDF value of a vertex represents a positional relationship between the vertex and the surface of the 3D entity model, and an absolute value of the SDF value of the vertex represents a distance between the vertex and the surface of the 3D entity model; and
the computer program, when executed by the processor, further causes the computer device to, when determining the subdivisible voxels and mergeable voxels:
determine a minimum absolute value among the absolute values corresponding to the SDF values of the vertices of the initialized voxels;
in response to the minimum absolute value being less than a subdivision threshold and at least two vertices with SDF values of opposite signs existing in an initialized voxel that includes a vertex corresponding to the minimum absolute value, determine the initialized voxel as a subdivisible voxel;
determine other initialized voxels, other than the subdivisible voxels, as non-subdivisible voxels; and
in response to an absolute value corresponding to an SDF value of a vertex of a non-subdivisible voxel being greater than a merge threshold, determine the non-subdivisible voxel as a mergeable voxel.

16. The computer device according to claim 14, wherein the computer program, when executed by the processor, further causes the computer device to:
determine position coordinates of the vertices of the initialized voxels; and
input the position coordinates into a multilayer perceptron to obtain the SDF values of the vertices of the initialized voxels.

17. The computer device according to claim 12, wherein the computer program, when executed by the processor, further causes the computer device to, when constructing the 3D mesh:
construct a dual grid corresponding to the 3D entity model based on dual verts corresponding to the voxels, each of the dual verts being a point that has duality with one of the voxels, and the dual grid representing the geometric shape of the surface of the 3D entity model; and
convert the dual grid to obtain the 3D mesh corresponding to the 3D entity model.

18. The computer device according to claim 17, wherein the computer program, when executed by the processor, further causes the computer device to, when constructing the dual grid:
determine the dual verts corresponding to the voxels based on position codes of vertices of the voxels; and
connect the dual vert of a first voxel with the dual vert of each of at least one second voxel adjacent to the first voxel to construct the dual grid corresponding to the 3D entity model, each of the at least one second voxel sharing a common vertex with the first voxel.

19. The computer device according to claim 18, wherein the computer program, when executed by the processor, further causes the computer device to, when determining the dual verts, for each voxel of the voxels:
determine a voxel center point of the voxel based on the position codes of the vertices of the voxel; and
determine the voxel center point as the dual vert corresponding to the voxel.

20. A non-transitory computer-readable storage medium storing a computer program that, when executed by a processor, causes a computer device including the processor to:
obtain 3D spatial information corresponding to a 3D entity model;
perform voxel partitioning on the 3D entity model based on the 3D spatial information to determine voxels corresponding to the 3D entity model and connected in a tree structure, the voxels being distributed on a surface of the 3D entity model and representing a geometric shape of the surface of the 3D entity model; and
construct a 3D mesh corresponding to the 3D entity model based on the voxels.
